(19) United States
(12) Patent Application Publication
(10) Pub. No.: US 2026/0074868 A1
(43) Pub. Date: Mar. 12, 2026

(54) METHODS AND APPARATUS FOR DYNAMIC HARQ-ACK CODEBOOK FOR NETWORK-CONTROLLED REPEATERS

(71) Applicant: APPLE INC., Cupertino, CA (US)

(72) Inventors: Ankit Bhamri, Bad Nauheim (DE); Hong He, San Jose, CA (US); Chunhai Yao, Beijing (CN); Wei Zeng, San Diego, CA (US); Dawei Zhang, Saratoga, CA (US); Oghenekome Oteri, San Diego, CA (US); Huaning Niu, San Jose, CA (US); Weidong Yang, San Diego, CA (US); Chunxuan Ye, San Diego, CA (US)

(21) Appl. No.: 19/101,790

(22) PCT Filed: Aug. 11, 2022
(86) PCT No.: PCT/CN2022/111690

§ 371 Date: Feb. 6, 2025

(51) Int. Cl. H04L 5/00; H04L 1/1812

(52) U.S. Cl. CPC H04L 5/0055; H04L 1/1812

(57) ABSTRACT

Methods and apparatus are provided for wireless communication performed by a network-controlled repeater (NCR) configured to forward downlink (DL) channels or signals from a base station to a user equipment (UE). The NCR determines a duration for which hybrid automatic repeat request acknowledgement (HARQ-ACK) feedback is configured. The NCR determines a number of measurements of the DL channels or signals for which a single HARQ-ACK bit is reported. The NCR determines, based on the number of measurements and a comparison with a success threshold for each of the measurements, an acknowledgement (ACK) or negative acknowledgement (NACK) for each configured HARQ-ACK bit in a first sequence of HARQ-ACK bits. The NCR constructs a dynamic HARQ-ACK codebook to send to the base station. The dynamic HARQ-ACK codebook includes at least the first sequence of HARQ-ACK bits.

### TECHNICAL FIELD

This application relates generally to wireless communication systems, including network-controlled repeaters.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®)

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating a network-controlled repeater (NCR) according to certain embodiments.

FIG. 2 is a flowchart of a method for configuring a dynamic hybrid automatic repeat request acknowledgement (HARQ-ACK) codebook for an NCR according to one embodiment.

FIG. 3 is a flowchart of a method for an NCR according to one embodiment.

FIG. 4 is a flowchart of a method for a base station according to one embodiment.

FIG. 5 illustrates a process of determining HARQ-ACK bits for a HARQ-ACK group according to one embodiment.

FIG. 6A illustrates a process of determining HARQ-ACK bits for a HARQ-ACK group for multiple component carriers according to one embodiment.

FIG. 6B illustrates a process of determining HARQ-ACK bits for a HARQ-ACK group for multiple component carriers according to one embodiment.

FIG. 7 is a flowchart of a method of wireless communication performed by an NCR configured to forward downlink (DL) channels or signals from a base station to a UE according to one embodiment.

FIG. 8 is a flowchart of a method of wireless communication performed by a base station according to one embodiment.

FIG. 9 illustrates multiple sets of cDAI and tDAI corresponding to different HARQ-ACK groups according to one embodiment.

FIG. 10 is a method for wireless communication by a network device according to one embodiment.

FIG. 11 illustrates an example architecture of a wireless communication system, according to embodiments disclosed herein.

FIG. 12 illustrates a system for performing signaling between a wireless device and a network device, according to embodiments disclosed herein.

### DETAILED DESCRIPTION

Various embodiments are described with regard to a UE and an NCR. However, references to a UE and/or an NCR are merely provided for illustrative purposes. The example embodiments may be utilized with any electronic component that may establish a connection to a network and is configured with the hardware, software, and/or firmware to exchange information and data with the network. Therefore, the UE and/or the NCR as described herein are used to represent any appropriate electronic component.

In a cellular communication system, a network-controlled repeater (NCR) may be deployed in an area where the wireless coverage provided by the base station is weak. NCRs may be low cost network nodes to help improve the coverage. Unlike radio frequency (RF) repeaters used in prior systems, an NCR may be configured to provide forwarding in selected directions using beam forming. From a UE's perspective, the NCR is transparent (i.e., the NCR forwards signals to and from the UE as if the UE were communicating directly with a base station).

It may be useful to identify side control information to use for an NCR including an assumption of maximum transmission power. The side control information may include, for example, beamforming information, timing information to align transmission and reception boundaries of the network-controlled repeater, information on uplink (UL) and downlink (DL) time division duplex (TDD) configuration, on-off information for efficient interference management and improved energy efficiency, and/or power control information for efficient interference management (e.g., as a second priority).

Further, it may be useful to identify Layer 1 (L1) and/or Layer 2 (L2) signaling (including an L1/L2 configuration) to carry the side control information. For L1/L2 signaling in certain communication systems, agreements have been made to consider uplink control information (UCI) feedback including hybrid automatic repeat request (HARQ) acknowledgment (ACK) feedback from an NCR to a gNB. For the gNB to determine if the side control information transmitted to the NCR is received and/or decoded correctly, for example, it has been discussed in 3GPP that the NCR may be able to send feedback HARQ-ACK to the gNB.

Aspects of certain embodiments disclosed herein are related to dynamic HARQ-ACK codebook at the NCR. For a UE, typically, if the network wants the UE to avoid a very large HARQ-ACK codebook (as could possibly be case with a Type-1 HARQ-ACK codebook, i.e., semi-static HARQ-ACK codebook), then the network can configure a dynamic HARQ-ACK codebook (Type-2 HARQ-ACK codebook) to the UE. The dynamic HARQ-ACK codebook allows the UE to correctly determine the sequence and number of HARQ-ACKs corresponding to actually scheduled physical downlink shared channels (PDSCHs) by a scheduling downlink control information (DCI) (i.e., rather than for all PDSCH transmission occasions). For an NCR, it may also be beneficial to introduce a dynamic HARQ-ACK codebook.

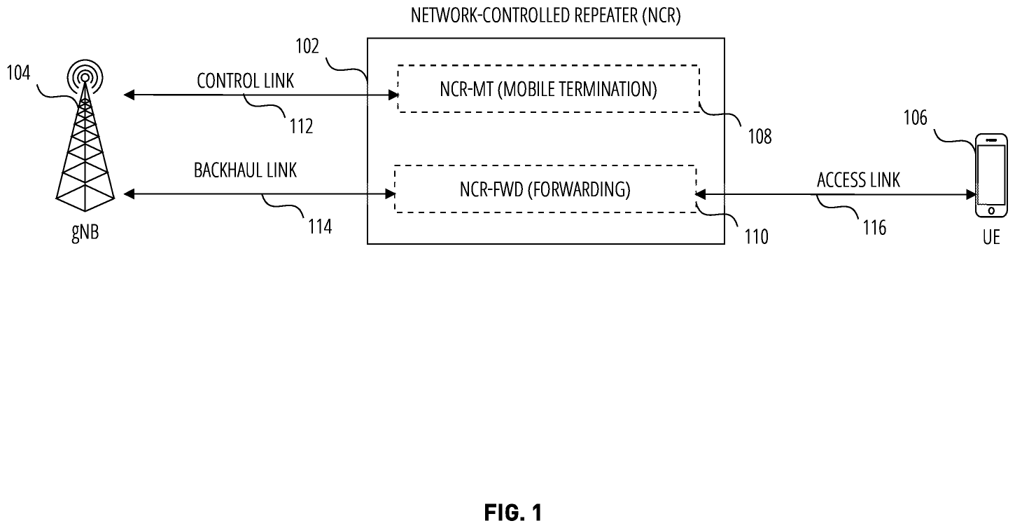

FIG. 1 is a block diagram illustrating an NCR 102 in communication with a gNB 104 and a UE 106 according to certain embodiments. The NCR 102 includes a mobile termination (MT) (shown as NCR-MT 108) and a forwarding entity (shown as NCR-Fwd 110). The NCR 102 is a function entity to communicate with the gNB 104 via a control link 112 (C-link) to enable information exchanges (e.g., side control information). The control link 112 may be based on the NR Uu interface. The side control information may be sent from the gNB 104 for the NCR-MT 108 in PDCCH transmissions, PDSCH transmissions, or in a combination of PDCCH and PDSCH transmissions. The side control information may at least be for the control by the NCR 102 of the NCR-Fwd 110. The NCR-Fwd 110 is a function entity to perform the amplify-and-forwarding of UL/DL RF signals between the gNB 104 and the UE 106 via a backhaul link 114 and an access link 116. The behavior of the NCR-Fwd 110 may be controlled according to the received side control information from gNB 104.

For the NCR-MT 108, the configurations from radio resource control (RRC) and/or operations, administration and maintenance (OAM), or which are hard-coded, may include the configurations of physical (PHY) channels to carry the L1/L2 signaling, as well as the configurations of the L1/L2 signaling. The configurations of the PHY channels to carry the L1/L2 signaling may include, for example, the configurations for receiving physical downlink control channel (PDCCH) and PDSCH, the configurations for transmitting physical uplink control channel (PUCCH) (if needed), and/or the configurations for transmitting physical uplink shared channel (PUSCH) (if needed). The configurations of L1/L2 signaling may include, for example, the configurations for DCI, the configurations for UCI (if needed), and/or the configurations for media access control (MAC) control element (CE) (if needed).

For the parameters in the configurations for L1/L2 signaling, the existing parameters for PDCCH, PDSCH, PUCCH, PUSCH, DCI, UCI and MAC CE in, for example 3GPP Release 17 (Rel-17) may be used as a baseline for subsequent releases. This may not imply, however, that all Rel-17 parameters will be supported for the NCR-MT 108, nor that the PUCCH, PUSCH, UCI and MAC CE are currently agreed to be supported.

As discussed above, for the NCR 102 disclosed herein, it may be beneficial to use a dynamic HARQ-ACK codebook. As the NCR-MT 108 is expected to be scheduled to receive PDSCH from the network with side control information, so the corresponding HARQ-ACK may also be specified. Also, the HARQ-ACK feedback corresponding to PDCCH is also beneficial for the case when PDCCH is only transmitting side control information, but not scheduling PDSCH to be received by the NCR-MT 108.

In addition, or in other embodiments, HARQ-ACK feedback by the NCR 102 to the network corresponding to a DL transmission (including PDSCH, PDCCH, DL RS, etc.) is received (without decoding) from the network and forwarded to UE(s) by the NCR-Fwd 110. This may be used for radio link/beam monitoring between the network and the NCR-Fwd 110 (and for the NCR-MT 108 considering that they are co-located), rather than being based on decoding.

Considering the above types of HARQ-ACK feedback corresponding to scheduled PDSCH for NCR-MT 108, scheduled PDCCH for the NCR-MT 108, and forwarding downlink (and/or forwarding uplink) for the NCR-Fwd 110, certain embodiments disclosed herein provide solutions to determine and construct dynamic HARQ-ACK codebook for the NCR 102 by taking into account that the HARQ-ACK feedback corresponding to forwarding channels may be for radio link/beam monitoring for the backhaul link 114 (and/or the access link 116).

### NCR Configured with Three HARQ-ACK Groups

In certain embodiments, the NCR 102 is configured with three HARQ-ACK groups that are concatenated together to construct one HARQ-ACK codebook for transmitting HARQ-ACK feedback to the gNB 104 via an uplink channel (e.g., PUCCH) using the control link 112 between the network and the NCR-MT 108. The three HARQ-ACK groups include a first HARQ-ACK group 1(HARQ-ACK Group1) that is constructed by a sequence of HARQ-ACK bits corresponding to PDCCH transmissions (e.g., to transmit side control information or for DL scheduling) to be received by the NCR-MT 108. A second HARQ-ACK group (HARQ-ACK Group2) is constructed by a sequence of HARQ-ACK bits corresponding to actually scheduled PDSCH transmissions (e.g., to transmit side control information) to be received by the NCR-MT 108. A third HARQ-ACK group (HARQ-ACK Group3) is constructed by HARQ-ACK bits corresponding to the radio link and/or beam quality between the gNB 104 and the NCR-Fwd 110 that is used for transmitting downlink channels or signals to the NCR-Fwd 110 for forwarding to the UE 106 (and possibly to one or more other UEs). In some scenarios, the radio link and/or beam between the gNB 104 and the NCR-MT 108 can be the same as the radio link and/or the beam between the gNB 104 and the NCR-Fwd 110. In this scenario, either or both the links can be used to determine the bits for third HARQ-ACK group.

According to one aspect, the configured HARQ-ACK groups may be concatenated in a sequential manner (e.g., least significant bit (LSB) to most significant bit (MSB)) to construct the HARQ-ACK codebook. In other words, the bits corresponding to one HARQ-ACK group are added, followed by bits from another HARQ-ACK group (if configured), and thereafter followed by bits from the last HARQ-ACK group (if configured). The actual sequence or order of combining multiple HARQ-ACK groups can either be configured to UE or fixed (e.g., in a standard or specification). Alternatively, the sequence can be implicitly determined based on occurrence of the corresponding transmission associated with each of the HARQ-ACK groups. For example, within the valid duration (of slots) for which HARQ-ACK codebook is constructed, if the first transmission is PDCCH for reception by the NCR-MT 108, then the first in the sequence is HARQ-ACK Group1, as described above.

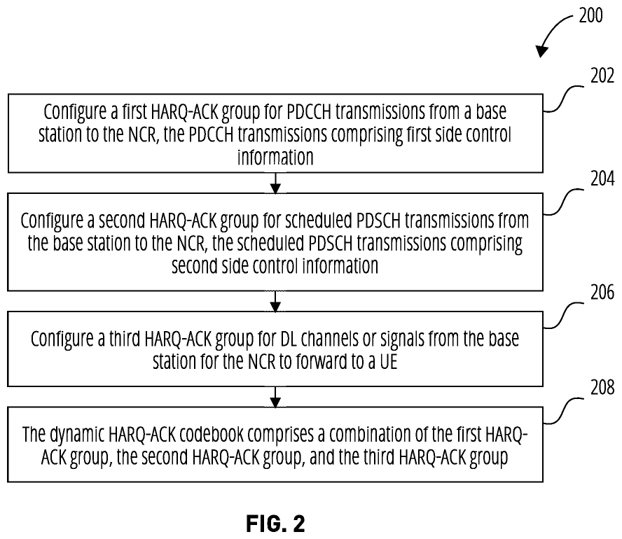

FIG. 2 is a flowchart of a method 200 for configuring a dynamic hybrid automatic repeat request acknowledgement (HARQ-ACK) codebook for a network-controlled repeater (NCR) according to one embodiment. In block 202, the method 200 includes configuring a first HARQ-ACK group for physical downlink control channel (PDCCH) transmissions from a base station to the NCR. The PDCCH transmissions include first side control information. In block 204, the method 200 includes configuring a second HARQ-ACK group for scheduled physical downlink shared channel (PDSCH) transmissions from the base station to the NCR. The scheduled PDSCH transmissions include second side control information. In block 206, the method 200 includes configuring a third HARQ-ACK group for downlink (DL) channels or signals from the base station for the NCR to forward to a user equipment (UE). As shown in block 208, the dynamic HARQ-ACK codebook comprises a combination of the first HARQ-ACK group, the second HARQ-ACK group, and the third HARQ-ACK group.

In certain embodiments of the method 200, the first HARQ-ACK group comprises a first sequence of HARQ-ACK bits corresponding to the PDCCH transmissions to be decoded by a mobile termination of the NCR (NCR-MT).

In certain embodiments of the method 200, the second HARQ-ACK group comprises a second sequence of HARQ-ACK bits corresponding to the scheduled PDSCH transmissions to be decoded by the NCR-MT.

In certain embodiments of the method 200, the third HARQ-ACK group comprises a determined number of HARQ-ACK bits corresponding to at least one of a radio link quality and a beam quality between the base station and a forwarding entity of the NCR (NCR-Fwd).

In certain embodiments of the method 200, the determined number of HARQ-ACK bits of the third HARQ-ACK group are based on a duration for which HARQ-ACK feedback is configured, a number of measurements of the DL channels or signals for which a single configured HARQ-ACK bit is reported, and an acknowledgement (ACK) or negative acknowledgement (NACK) for each configured HARQ-ACK bit in a sequence.

In certain embodiments, the method 200 further comprises concatenating the first sequence of HARQ-ACK bits of the first HARQ-ACK group, the second sequence of HARQ-ACK bits of the second HARQ-ACK group, and the determined number of HARQ-ACK bits of the third HARQ-ACK group to generate the dynamic HARQ-ACK codebook. In one embodiment, the concatenating comprises concatenation in a sequential manner based on a predetermined order for the first HARQ-ACK group, the second HARQ-ACK group, and the third HARQ-ACK group. In another embodiment, the concatenating comprises concatenation in an implicit order for the first HARQ-ACK group, the second HARQ-ACK group, and the third HARQ-ACK group based on an occurrence of corresponding transmissions.

In certain embodiments, the method 200 further comprises configuring a fourth HARQ-ACK group for uplink (UL) channels or signals from the UE for the NCR to forward to the base station. The HARQ-ACK bits for the fourth HARQ-ACK group can be determined based on the radio and/or link quality of the uplink channels or signals from the UE to the NCR-Fwd on the access link.

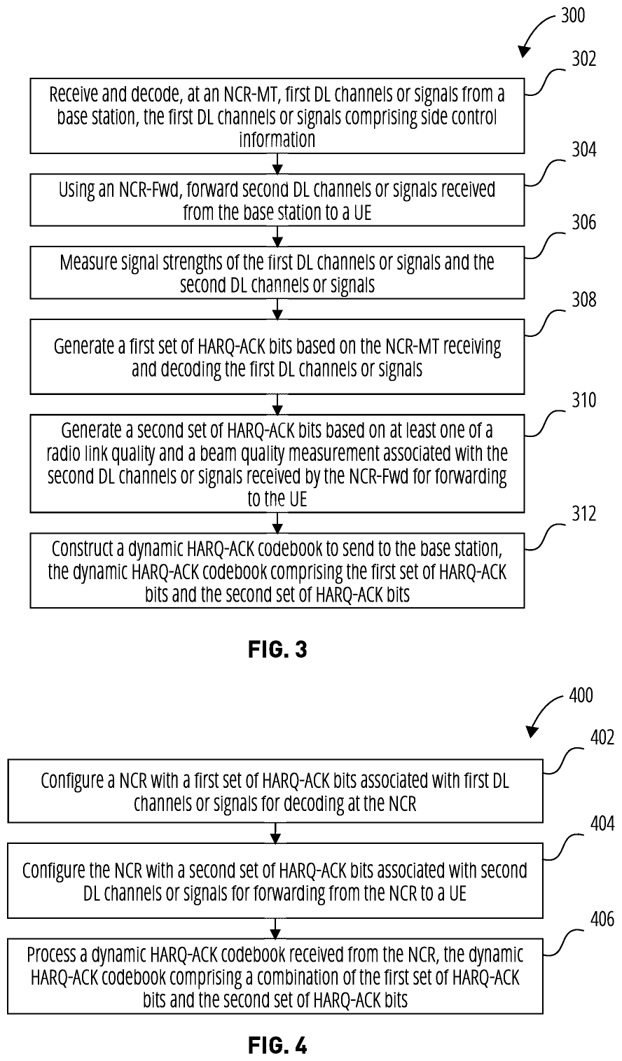

FIG. 3 is a flowchart of a method 300 for a network-controlled repeater (NCR) according to one embodiment. In block 302, the method 300 includes receiving and decoding (e.g., with an NCR-MT) first downlink (DL) channels or signals from a base station. The first DL channels or signals comprise side control information. In block 304, the method 300 includes forwarding (e.g., with an NCR-Fwd) second DL channels or signals received from the base station to a user equipment (UE). In block 306, the method 300 includes measuring (e.g., with measurement circuitry) signal strengths of the first DL channels or signals and the second DL channels or signals. In block 308, the method 300 includes generating a first set of hybrid automatic repeat request acknowledgement (HARQ-ACK) bits based on the NCR-MT receiving and decoding the first DL channels or signals. In block 310, the method 300 includes generating a second set of HARQ-ACK bits based on at least one of a radio link quality and a beam quality measurement associated with the second DL channels or signals received by the NCR-Fwd for forwarding to the UE. In block 312, the method 300 includes constructing a dynamic HARQ-ACK codebook to send to the base station. The dynamic HARQ-ACK codebook comprises the first set of HARQ-ACK bits and the second set of HARQ-ACK bits.

In certain embodiments of the method 300, the first DL channels or signals comprise a physical downlink control channel (PDCCH) comprising the side control information, DL scheduling information, or a combination of the side control information and the DL scheduling information.

In certain embodiments of the method 300, the second DL channels or signals comprise a physical downlink shared channel (PDSCH) comprising the side control information.

In certain embodiments of the method 300, measuring includes to measure a first signal strength of a physical downlink control channel (PDCCH) carrying the side control information, a second signal strength of a physical downlink shared channel (PDSCH) carrying the side control information, and a third signal strength of the second DL channels or signals for the NCR-Fwd to forward from the base station to the UE.

In certain embodiments of the method 300, measuring includes to measure signal strengths of uplink (UL) channels or signals received from the UE for forwarding to the base station. The second set of HARQ-ACK bits may be associated with the signal strengths UL channels or signals.

In certain embodiments, the method 300 further include generating a third set of HARQ-ACK bits associated with the signal strengths UL channels or signals.

FIG. 4 is a flowchart of a method 400 for a base station according to one embodiment. In block 402, the method 400 includes configuring a network-controlled repeater (NCR) with a first set of HARQ-ACK bits associated with first downlink (DL) channels or signals for decoding at the NCR. In block 404, the method 400 includes configuring the NCR with a second set of HARQ-ACK bits associated with second DL channels or signals for forwarding from the NCR to a user equipment (UE). In block 406, the method 400 includes processing a dynamic HARQ-ACK codebook received from the NCR. The dynamic HARQ-ACK codebook comprises a combination of the first set of HARQ-ACK bits and the second set of HARQ-ACK bits.

In certain embodiments of the method 400, the first set of HARQ-ACK bits corresponds to at least one of a first HARQ-ACK group and a second HARQ-ACK group. The first HARQ-ACK group is associated with physical downlink control channel (PDCCH) transmissions comprising at least one of first side control information and downlink (DL) scheduling information. The second HARQ-ACK group is associated with scheduled physical downlink shared channel (PDSCH) transmissions comprising second side control information.

In certain embodiments of the method 400, the second set of HARQ-ACK bits corresponds to a third HARQ-ACK group based on a duration for which HARQ-ACK feedback is configured, a number of measurements of the second DL channels or signals for which a single configured HARQ-ACK bit is reported, and an acknowledgement (ACK) or negative acknowledgement (NACK) for each configured HARQ-ACK bit in a sequence.

In certain embodiments, the method 400 further includes configuring the NCR with a third set of HARQ-ACK bits associated with uplink (UL) channels or signals received from the UE for forwarding to the base station. The dynamic HARQ-ACK codebook further includes the third set of HARQ-ACK bits.

### HARQ-ACK Group3 Design

In one embodiment, an NCR is configured by a wireless network to determine a number of HARQ-ACK bits for HARQ-ACK Group3 corresponding to radio link and/or beam quality between a gNB or transmission reception point (TRP) and an NCR-Fwd (and NCR-MT assuming similar radio link and beam) by measuring DL channels or signals configured for forwarding to UE(s). The HARQ-ACK bits for HARQ-ACK Group3 may be determined by determining a duration (e.g., number of slots or symbols) for which the HARQ-ACK feedback is configured, determining a number of measurements of DL channels or signals for which one configured HARQ-ACK bit is reported, and determining an ACK or negative acknowledgement (NACK) for each configured HARQ-ACK bit in the sequence.

The duration (e.g., number of slots or symbols) for which the HARQ-ACK feedback is configured may be predetermined or semi-statically configured. For example, the duration may be semi-statically configured by information in a PDCCH, and the configured duration may be used for a certain period after receiving the PDCCH or until a newly configured duration is received. A shorter duration may result in reduced latency, whereas a longer duration may help reduce overhead.

In one embodiment, the number of measurements of DL channels or signals for which one HARQ-ACK bit is reported is configured explicitly by the network. For example, the NCR may be configured to measure four consecutive DL channels or signals received for forwarding to determine one HARQ-ACK bit. In another embodiment, the number of measurements of DL channels or signals for which one HARQ-ACK bit is reported is implicitly configured by the network in terms of duration. For example, one HARQ-ACK bit may be configured for a duration of two slots, i.e. all the downlink channels or signals measured within the two slots duration are used to determine HARQ-ACK bit. In another embodiment, one HARQ-ACK bit is configured for the entire determined duration (e.g., number of slots) for which the HARQ-ACK feedback is configured. In another embodiment, one HARQ-ACK bit is configured corresponding to each DL channel or signal.

In one embodiment, to determine ACK or NACK for each of the configured HARQ-ACK bit in the sequence, the NCR is configured by the network with a threshold to determine a success or failure for each of received DL channel or signal to be forwarded. The NCR may be configured by the network with a success (or alternatively failure) ratio or percentage threshold to determine whether to report ACK or NACK. For example, if the NCR is configured with a 75% success threshold for measurements over four DL channels or signals, then the NCR reports ACK if three or four of the measurements are above the threshold. Otherwise, the NCR reports NACK.

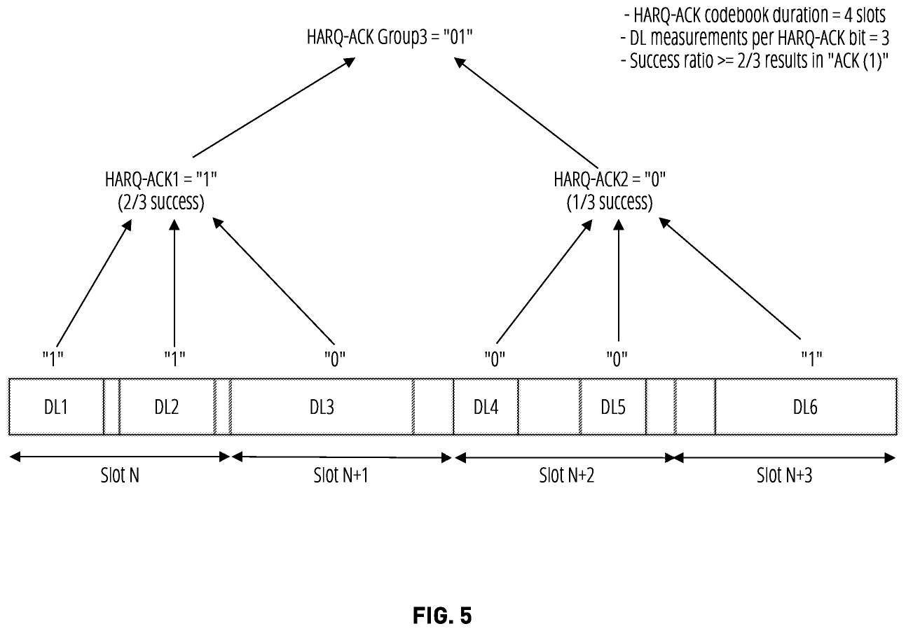

By way of example, FIG. 5 illustrates a process of determining HARQ-ACK bits for HARQ-ACK Group3 according to one embodiment. In this example, the HARQ-ACK codebook duration is four slots (Slot N, Slot N+1, Slot N+2, and Slot N+3). As discussed above, the duration of four slots may be predetermined or semi-statically configured.

In the example shown in FIG. 5, there are three DL measurements per HARQ-ACK bit. For a first HARQ-ACK bit (HARQ-ACK1), the NCR measures DL signals DL1, DL2, and DL3. Per the measurements, the NCS determines that DL1 is successfully received (“1”), DL2 is successfully received (“1”), and DL3 is unsuccessfully received (“0”). Similarly, for a second HARQ-ACK bit (HARQ-ACK2), the NCR measures DL signals DL4, DL5, and DL6 to determine that DL4 is unsuccessfully received (“0”), DL5 is unsuccessfully received (“0”), and DL6 is successfully received (“1”). The NCR may determine whether a particular DL channel or signal is successfully received by comparing the corresponding measurement to a radio link and/or beam quality threshold. For example, if a measured signal strength, reference signal received power (RSRP), reference signal received quality (RSRQ), or signal to interference and noise ratio (SINR) exceeds a threshold value, then the NCR determines that corresponding DL channel or signal is successfully received (“1”). On the other hand, if the measured signal strength, RSRP, RSRQ, or SINR does not exceed the threshold value, then the NCR determines that the corresponding DL channel or signal is not successfully received (“0”).

In the example shown in FIG. 5, a success ratio ≥2/3 results in “ACK(1)” for the corresponding HARQ-ACK bit. As shown, for HARQ-ACK1 corresponding to the measurement of DL1, DL2, and DL3, the NCR determines a 2/3 success ratio (DL1 and DL2 are successful, whereas DL3 is unsuccessful). Thus, the NCR determines that HARQ-ACK1=“1”. For HARQ-ACK2 corresponding to the measurement of DL4, DL5, and DL6, the NCR determines a 1/3 success ratio (DL6 is successful, whereas DL4 and DL5 are unsuccessful). Thus, the NCR determines that HARQ-ACK2=“0”. Accordingly, in the example shown in FIG. 5, HARQ-ACK Group3=“01”.

### HARQ-ACK Group3 for Multiple Component Carriers

In certain embodiments, the NCR is configured to forward DL channels or signals to one or more UEs on multiple component carriers (CCs). In one such embodiment, the network configures the NCR to determine HARQ-ACK bits for HARQ-ACK Group3 separately for each CC. The NCR may measure the signal strength of all the DL channels or signals across one carrier. If the ratio or percentage of DL channels or signals above the configured signal threshold is above a minimum required threshold, the NCR reports one ACK for the carrier. Otherwise, the NCR reports one NACK for the one carrier. Similarly, the NCR determines an ACK or NACK for each of the configured CCs on which DL channels or signals are scheduled for forwarding to the UE(s). For example, if four CCs are configured, then the NCR reports four bits corresponding to HARQ-ACK Group3. In a more general realization, counting may be done first across all DL transmissions in one carrier, followed by a next subcarrier, and so forth, and one HARQ-ACK bit may be determined according to the number of DL measurements.

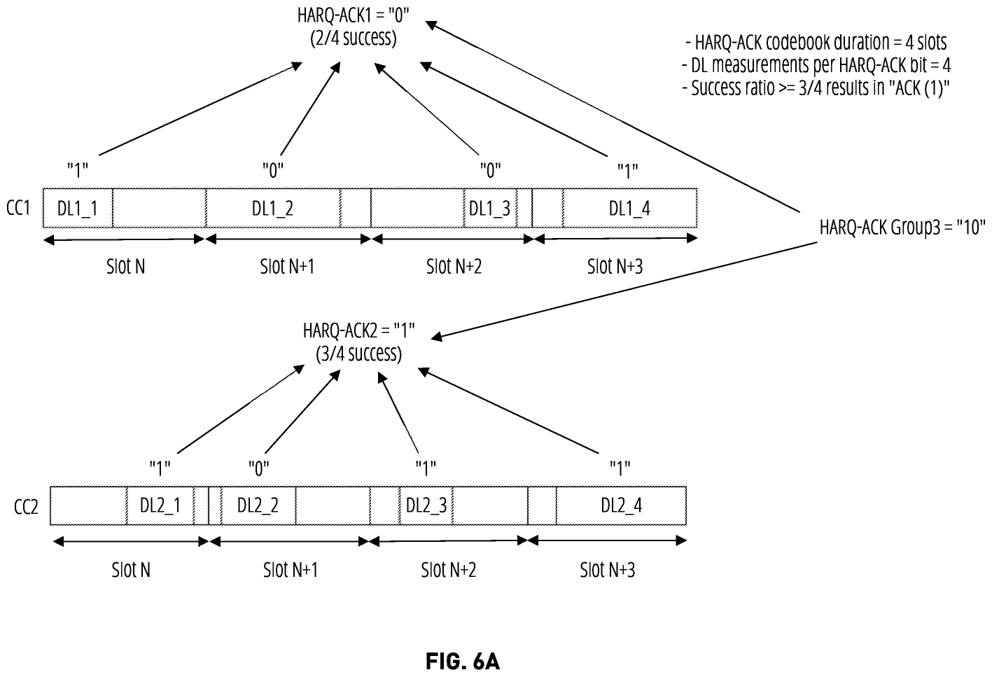

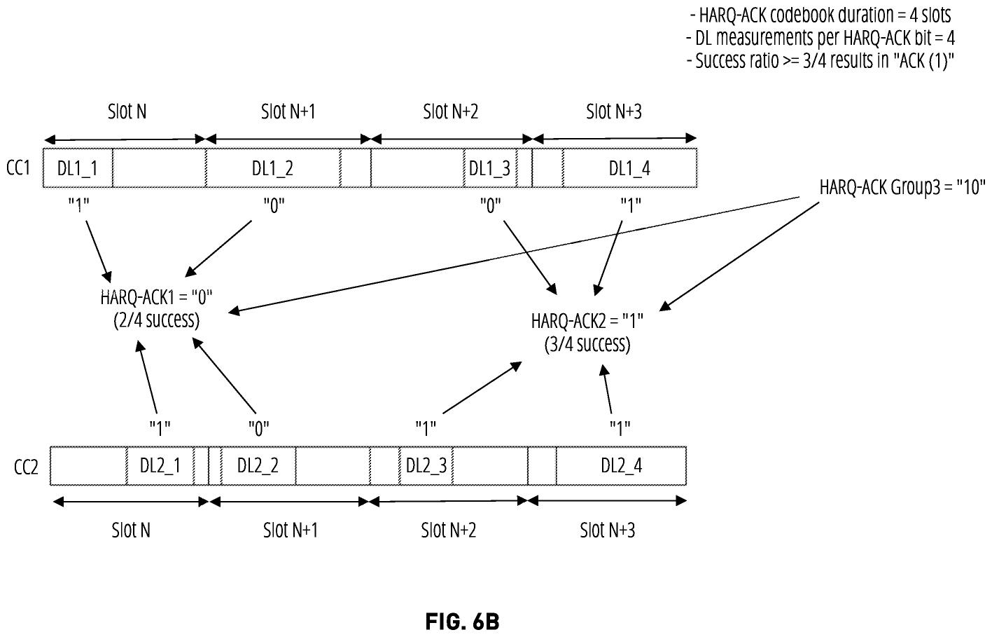

For example, FIG. 6A illustrates a process of determining HARQ-ACK bits for HARQ-ACK Group3 for multiple component carriers according to one embodiment. In this example, the HARQ-ACK codebook duration is four slots (Slot N, Slot N+1, Slot N+2, and Slot N+3). As discussed above, the duration of four slots may be predetermined or semi-statically configured.

In the example shown in FIG. 6A, there are four DL measurements per HARQ-ACK bit and a success ratio greater than or equal to 3/4 results in “ACK (1)”. For a first component carrier (CC1), the NCR determines a first HARQ-ACK bit (HARQ-ACK1) by measuring DL signals DL1_1, DL1_2, DL1_3, and DL1_4 within the four slots. Per the measurements, the NCS determines that DL1_1 is successfully received (“1”), DL1_2 is unsuccessfully received (“0”), DL1_3 is unsuccessfully received (“0”), and DL1_4 is successfully received (“1”). Thus, the NCR determines that HARQ-ACK1=“0”.

Similarly, for a second component carrier (CC2), the NCR determines a second HARQ-ACK bit (HARQ-ACK2) by measuring DL signals DL2_1, DL2_2, DL2_3, and DL2_4 within the four slots. Per the measurements, the NCS determines that DL2_1 is successfully received (“1”), DL2_2 is unsuccessfully received (“0”), DL2_3 is successfully received (“1”), and DL2_4 is successfully received (“1”). Thus, the NCR determines that HARQ-ACK2=“1”. Accordingly, in the example shown in FIG. 6A, HARQ-ACK Group3=“10”.

In another embodiment when the NCR is configured to forward DL channels or signals to one or more UEs on multiple CCs, the network configures the NCR to determine HARQ-ACK bits for HARQ-ACK Group3 by determining one HARQ-ACK bit per transmission occasion with scheduled DL channels or signals across all CCs. A similar method is applied to determine ACK or NACK depending on the configured threshold for signal strength and the ratio or percentage of downlink channels or signals above the threshold. In a more general realization, counting may be done first for all DL transmissions within a slot across all CCs, followed by a next slot, and so forth, and one HARQ-ACK bit may be determined according to the number of DL measurements.

For example, FIG. 6B illustrates a process of determining HARQ-ACK bits for HARQ-ACK Group3 for multiple component carriers according to one embodiment. In this example, the HARQ-ACK codebook duration is four slots (Slot N, Slot N+1, Slot N+2, and Slot N+3). As discussed above, the duration of four slots may be predetermined or semi-statically configured.

In the example shown in FIG. 6B, there are four DL measurements per HARQ-ACK bit and a success ratio greater than or equal to 3/4 results in “ACK (1)”. For a first time period or transmission occasion(s), the NCR determines a first HARQ-ACK bit (HARQ-ACK1) by measuring DL signals DL1_1, DL1_2, DL2_1, and DL2_2 in Slot N and Slot N+1 across both CC1 and CC2. Per the measurements, the NCS determines that DL1_1 is successfully received (“1”), DL1_2 is unsuccessfully received (“0”), DL2_1 is successfully received (“1”), and DL2_2 is unsuccessfully received (“0”). Thus, the NCR determines that HARQ-ACK1=“0”.

Similarly, for a second time period or transmission occasion(s), the NCR determines a second HARQ-ACK bit (HARQ-ACK2) by measuring DL signals DL1_3, DL1_4, DL2_3, and DL2_4 in Slot N+2 and Slot N+3 across both CC1 and CC2. Per the measurements, the NCS determines that DL1_3 is unsuccessfully received (“0”), DL1_4 is successfully received (“1”), DL2_3 is successfully received (“1”), and DL2_4 is successfully received (“1”). Thus, the NCR determines that HARQ-ACK2=“1”. Accordingly, in the example shown in FIG. 6B, HARQ-ACK Group3=“10”.

In another embodiment, the network configures the NCR to report a single HARQ-ACK bit corresponding to all the downlink channels or signals across all the CCs.

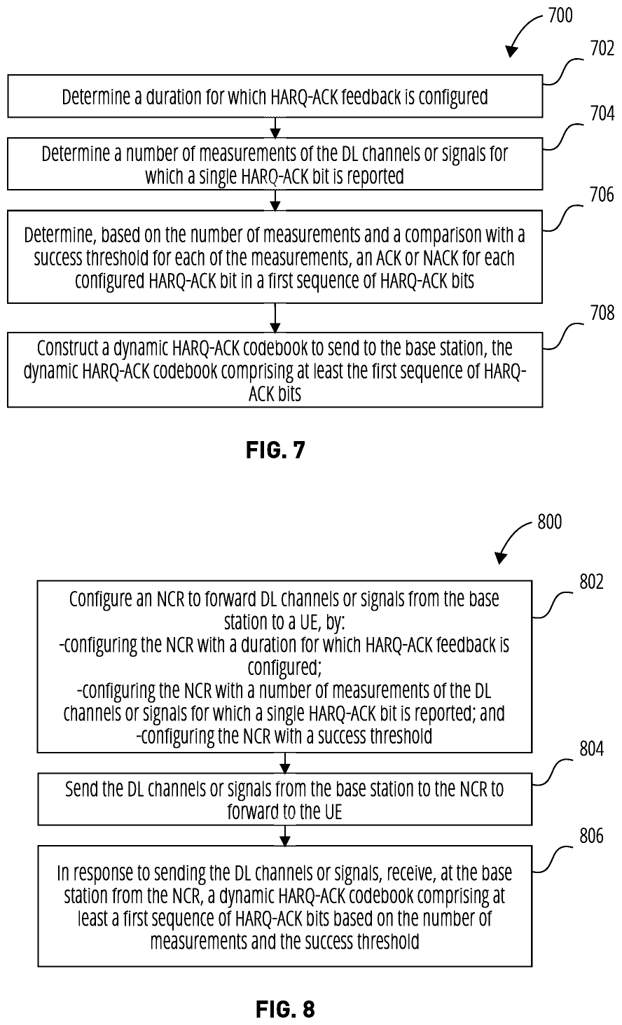

FIG. 7 is a flowchart of a method 700 of wireless communication performed by a network-controlled repeater (NCR) configured to forward downlink (DL) channels or signals from a base station to a user equipment (UE) according to one embodiment. In block 702, the method 700 includes determining a duration for which hybrid automatic repeat request acknowledgement (HARQ-ACK) feedback is configured. In block 704, the method 700 includes determining a number of measurements of the DL channels or signals for which a single HARQ-ACK bit is reported. In block 706, the method 700 includes determining, based on the number of measurements and a comparison with a success threshold for each of the measurements, an acknowledgement (ACK) or negative acknowledgement (NACK) for each configured HARQ-ACK bit in a first sequence of HARQ-ACK bits. In block 708, the method 700 includes constructing a dynamic HARQ-ACK codebook to send to the base station, the dynamic HARQ-ACK codebook comprising at least the first sequence of HARQ-ACK bits.

In certain embodiments of the method 700, determining the ACK or NACK comprises: performing measurements of the DL channels or signals over the duration to produce measurement results indicating whether the DL channels or signals were successfully received or unsuccessfully received; and comparing groups of the measurement results, according to the number of the measurements for which the single HARQ-ACK bit is reported, to the success threshold.

In certain embodiments of the method 700, determining the number of measurements for which the single HARQ-ACK bit is reported comprises processing an explicit indication of the number from the base station.

In certain embodiments of the method 700, determining the number of measurements for which the single HARQ-ACK bit is reported comprises processing an implicit indication of the number from the base station, the implicit indication corresponding to a number of slots or symbols.

In certain embodiments of the method 700, determining the number of measurements for which the single HARQ-ACK bit is reported corresponds to a total number of the DL channels or signals received over the duration.

In certain embodiments of the method 700, determining the number of the measurements for which the single HARQ-ACK bit is reported corresponds to a single one of the DL channels or signals.

In certain embodiments, the method 700 further includes receiving an indication of the success threshold from the base station, wherein the indication of the success threshold comprises a ratio or a percentage of successful receptions to overall transmissions of the DL channels or signals.

In certain embodiments of the method 700, the NCR is configured to forward the DL channels or signals on multiple component carriers, and the method 700 further comprises: determining, per component carrier of the multiple component carriers, the number of measurements of the DL channels or signals for which the single HARQ-ACK bit is reported; and determining, per component carrier of the multiple component carriers, the ACK or the NACK by measuring a signal strength of the DL channels or signals across a single component carrier, wherein the dynamic HARQ-ACK codebook comprises a corresponding HARQ-ACK bit for each of the multiple component carriers.

In certain embodiments of the method 700, the NCR is configured to forward the DL channels or signals on multiple component carriers, and the method 700 further comprises: determining, per transmission occasion across the multiple component carriers, the number of measurements of the DL channels or signals for which the single HARQ-ACK bit is reported; and determining, per transmission occasion across the multiple component carriers, the ACK or the NACK by measuring a signal strength of the DL channels or signals of a single transmission occasion, wherein the dynamic HARQ-ACK codebook comprises a corresponding HARQ-ACK bit for each transmission occasion.

In certain embodiments of the method 700, the NCR is configured to forward the DL channels or signals on multiple component carriers, and the method 700 further comprises reporting the single HARQ-ACK bit corresponding to all of the DL channels or signals across the multiple component carriers.

In certain embodiments of the method 700, constructing the dynamic HARQ-ACK codebook comprises concatenating the first sequence of HARQ-ACK bits with a second sequence of HARQ-ACK bits corresponding to scheduled physical downlink shared channel (PDSCH) transmissions from the base station to a mobile termination of the NCR. In certain such embodiments, constructing the dynamic HARQ-ACK codebook further comprises concatenating the first sequence of HARQ-ACK bits with a third sequence of HARQ-ACK bits corresponding to physical downlink control channel (PDCCH) transmissions from the base station to the mobile termination of the NCR.

FIG. 8 is a flowchart of a method 800 of wireless communication performed by a base station according to one embodiment. In block 802, the method 800 includes configuring a network-controlled repeater (NCR) to forward downlink (DL) channels or signals from the base station to a user equipment (UE), by: configuring the NCR with a duration for which hybrid automatic repeat request acknowledgement (HARQ-ACK) feedback is configured; configuring the NCR with a number of measurements of the DL channels or signals for which a single HARQ-ACK bit is reported; and configuring the NCR with a success threshold. In block 804, the method 800 includes sending the DL channels or signals from the base station to the NCR to forward to the UE. In block 806, in response to sending the DL channels or signals, the method 800 includes receiving, at the base station from the NCR, a dynamic HARQ-ACK codebook comprising at least a first sequence of HARQ-ACK bits based on the number of measurements and the success threshold.

In certain embodiments of the method 800, the duration comprises a number of slots or symbols.

In certain embodiments of the method 800, configuring the NCR with a number of measurements comprises sending an explicit indication of the number from the base station to the NCR.

In certain embodiments of the method 800, configuring the NCR with the number of measurements comprises sending an implicit indication of the number from the base station, the implicit indication corresponding to a number of slots.

In certain embodiments of the method 800, configuring the NCR with the number of measurements comprises configuring the NCR to report the single HARQ-ACK bit for a total number of the DL channels or signals received over the duration.

In certain embodiments of the method 800, configuring the NCR with the number of measurements comprises configuring the NCR to report the single HARQ-ACK bit for a single one of the DL channels or signals.

In certain embodiments of the method 800, the success threshold comprises a ratio or a percentage of successful receptions to overall transmissions of the DL channels or signals.

In certain embodiments of the method 800, the DL channels or signals are communicated on multiple component carriers, and the method 800 further comprises configuring, per component carrier of the multiple component carriers, the NCR with the number of measurements of the DL channels or signals for which the single HARQ-ACK bit is reported, wherein the dynamic HARQ-ACK codebook comprises a corresponding HARQ-ACK bit for each of the multiple component carriers.

In certain embodiments of the method 800, the DL channels or signals are communicated on multiple component carriers, and the method 800 further comprises configuring, per transmission occasion across the multiple component carriers, the number of measurements of the DL channels or signals for which the single HARQ-ACK bit is reported, wherein the dynamic HARQ-ACK codebook comprises a corresponding HARQ-ACK bit for each transmission occasion.

In certain embodiments of the method 800, the dynamic HARQ-ACK codebook further comprises at least one of: a second sequence of HARQ-ACK bits corresponding to scheduled physical downlink shared channel (PDSCH) transmissions from the base station to a mobile termination of the NCR; and a third sequence of HARQ-ACK bits corresponding to physical downlink control channel (PDCCH) transmissions from the base station to the mobile termination of the NCR.

### cDAI and tDAI Determination of HARQ-ACK Groups

When the HARQ-ACK codebook size is dynamic, a downlink assignment index (DAI) may be used to reduce codebook size errors due to PDCCH detection failure. For example, a UE may receive DAIs in the DCI. The DAIs may include counter DAIs (cDAIs) and total DAIs (tDAIs). A cDAI may indicate a cumulative number of serving cell and PDCCH monitoring occasion pairs in which DL DCIs have been sent by the base station, up to the current serving cell and current PDCCH monitoring occasion. A tDAI may be used when multiple serving cells are present, such as in carrier aggregation. The tDAI may indicate the total number of serving cell and PDCCH monitoring occasions in which DL DCIs have been transmitted by the base station, up to the current PDCCH monitoring occasion. Thus, the same tDAI monitoring value may be used for all DCIs in the same PDCCH monitoring occasion.

If no DL DCI is missed, then ACK/NACKs corresponding to the received PDSCHs may be placed in a codebook in the same order as the cDAI. If a DL DCI is missed, then a NACK may be placed in the codebook in the position corresponding to the cDAI of the missed DL DCI. The UE may determine whether a DL DCI is missed by comparing consecutive cDAI values (for example, cDAI values of 0, then 1, then 3 may indicate that a DCI with a cDAI value of 2 was missed) or by comparing tDAIs and cDAIs of all DCIs in a given PDCCH monitoring occasion. The UE may generate HARQ feedback based at least in part on the codebook, and may provide the HARQ feedback to a base station. Thus, a UE may identify DCI that has been missed and may generate HARQ feedback based at least in part on cDAIs and tDAIs.

In certain embodiments disclosed herein, an NCR is configured with multiple cDAI and tDAI corresponding to different HARQ-ACK groups. For example, a first cDAI (cDAI1) and a first tDAI (tDAI1) is associated with HARQ-ACK Group1, wherein the counter value for cDAI1 is changed and the total value for tDAI1 is incremented only corresponding to actually scheduled PDCCH for reception at the NCR-MT. The cDAI1 and tDAI1 are not affected by actually scheduled PDSCH for reception at NCR-MT or DL channels or signals for forwarding by the NCR-Fwd.

A second cDAI (cDAI2) and a second tDAI (tDAI2) is associated with HARQ-ACK Group2, wherein the counter value for cDAI2 is changed and the total value for tDAI2 is incremented only corresponding to actually scheduled PDSCH for reception at the NCR-MT. The cDAI2 and tDAI2 are not affected by PDCCH (with side control information) or DL channels or signals for forwarding by the NCR-Fwd.

A third cDAI (cDAI3) and a third tDAI (tDAI3) is associated with HARQ-ACK Group3, wherein the counter value of cDAI is changed and the total value of tDAI is incremented only corresponding to scheduled DL channels or signals for forwarding by the NCR-Fwd. The cDAI3 and tDAI3 are not affected by actually scheduled PDSCH for reception at the NCR-MT. Scheduling of DL channels or signals for forwarding can be implicit or explicit. Implicit scheduling can be determined by configured or indicated beams for DL forwarding at the NCR-Fwd to UE(s).

In one embodiment, when multiple CCs are configured, the counting is done first on all DL transmissions in a transmission time interval (TTI) or slot across all CCs, followed by a next TTI or slot across all CCs, and so on. In another embodiment, when multiple CCs are configured, then counting is done first on all DL transmissions across all TTIs or slots in a CC, followed by a next CC across all TTIs or slots, and so on.

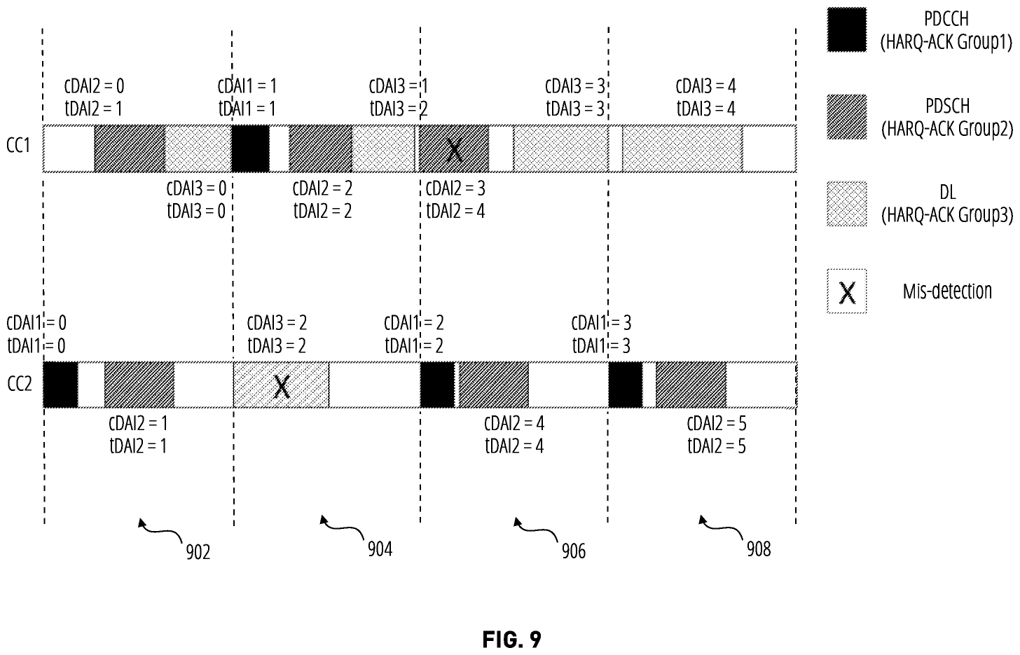

FIG. 9 illustrates multiple sets of cDAI and tDAI corresponding to different HARQ-ACK groups according to one embodiment. In particular, FIG. 9 shows how cDAI1, tDAI1 for HARQ-ACK Group1, cDAI2, tDAI2 for HARQ-ACK Group2, and cDAI3, tDAI3 for HARQ-ACK Group3 change across a duration for which the HARQ-ACK codebook is determined. The duration includes a first transmission occasion 902, a second transmission occasion 904, a third transmission occasion 906, and a fourth transmission occasion 908.

In the example illustrated in FIG. 9, for HARQ-ACK Group1, a first PDCCH transmission is received in the first transmission occasion 902 on CC2, which corresponds to cDAI1=0 and tDAI1=0. In the second transmission occasion 904, a second PDCCH transmission is received on CC1, which increments the count and total such that cDAI1=1 and tDAI1=1. In the third transmission occasion 906, a third PDCCH transmission is received on CC2, which increments the count and total such that cDAI1=2 and tDAI1=2. In the fourth transmission occasion 908, a fourth PDCCH transmission is received on CC2, which increments the count and total to cDAI1=3 and tDAI1=3. Thus, in this example, the NCR may place ACKs in HARQ-ACK Group1 corresponding to the received PDCCH transmissions in the same order as the cDAI1.

For HARQ-ACK Group2, a first PDSCH is received in the first transmission occasion 902 on CC1, which corresponds to cDAI2=0. A second PDSCH is also received in the first transmission occasion 902 on CC2, which increments the count such that cDAI2 =1. Because two PDSCH transmissions were received in the first transmission occasion 902, the total is updated twice (to 0 and again to 1) such that tDAI2=1 in the first transmission occasion 902. In the second transmission occasion 904, a third PDSCH transmission is received on CC1, which increments the count and total such that cDAI2=2 and tDAI2=2. In the third transmission occasion 906, a fourth PDSCH transmission is transmitted (but in this example is mis-detected or not successfully received) on CC1, which increments the count such that cDAI2=3. A fifth PDSCH transmission is also received in the third transmission occasion 906 on CC2, which increments the count such that cDAI2=4. Because there are two PDSCH transmissions in the third transmission occasion 906, the total is updated twice such that tDAI2=4 in the third transmission occasion 906. In the fourth transmission occasion 908, a sixth PDSCH transmission is received on CC2, which increments the count and total to cDAI2=5 and tDAI2=5. Thus, in this example, the NCR may place ACK/NACKs in HARQ-ACK Group2 corresponding to the received PDSCH transmissions in the same order as the cDAI2. For missed DL DCI, the NCR may place a NACK in the codebook in the position corresponding to the cDAI2 of the missed DL DCI. The NCR may determine whether a DL DCI is missed by comparing consecutive cDAI2 values (e.g., cDAI2=0, cDAI2=1, cDAI2=2, cDAI2=4, cDAI2=5 indicates that cDAI2=2 was missed) or by comparing tDAI2 and cDAI2 values of all DCIs in a given transmission occasion.

For HARQ-ACK Group3, a first DL transmission for forwarding is received in the first transmission occasion 902 on CC1, which corresponds to cDAI3=0 and tDAI3=0. In the second transmission occasion 904, a second DL transmission for forwarding is received on CC1, which increments the count such that cDAI3=1. A third DL transmission for forwarding is also transmitted (but in this example is mis-detected or not successfully received) on CC2, which increments the count such that cDAI3=2. Because there are two DL transmission for forwarding in the second transmission occasion 904, the total is updated twice such that tDAI3=2 in the second transmission occasion 904. In the third transmission occasion 906, a fourth DL transmission for forwarding is received on CC1, which increments the count and total such that cDAI3=3 and tDAI3=3. In the fourth transmission occasion 908, a fifth DL transmission for forwarding is received on CC1, which increments the count and total such that cDAI3=4 and tDAI3=4. Thus, in this example, the NCR may place ACK/NACKs in HARQ-ACK Group3 corresponding to the received DL transmissions for forwarding in the same order as the cDAI3. In certain such embodiments, the NCR may determine the number of HARQ-ACK bits and corresponding values for HARQ-ACK Group3 as described above (e.g., see FIG. 5, FIG. 6A, and/or FIG. 6B).

In certain embodiments, the control information format for indicating side control information to the NCR-MT may be configured to indicate more than one set of cDAI and tDAI corresponding to multiple HARQ-ACK groups. For example, when the control information format is transmitted to the NCR-MT for actually scheduling PDSCH for transmission to the NCR-MT and not scheduling DL channels or signals to the NCR-Fwd for forwarding to UE(s), then only one set of cDAI and tDAI values is signaled to the NCR corresponding to HARQ-ACK Group1. This also implies that there is no change to the cDAI and tDAI values for the other two HARQ-ACK groups, if configured.

As another example, when the control information format is transmitted to the NCR-MT for not scheduling PDSCH for transmission and not scheduling downlink channels or signals for forwarding, but just transmitting side control information, then only one set of cDAI and tDAI values is signaled to the NCR corresponding to HARQ-ACK Group2. This also implies that there is no change to the cDAI and tDAI values for the other two HARQ-ACK groups, if configured.

In yet another example, when the control information format is transmitted for not scheduling PDSCH for transmission, but transmitting side control information and scheduling downlink channels/signals for forwarding, then two sets of cDAI and tDAI values are signaled to the NCR corresponding to HARQ-ACK group 2 and HARQ-ACK Group3. This also implies that there is no change to the cDAI and tDAI values for HARQ-ACK Group1, if configured.

In some embodiments, HARQ-ACK Group2 is not configured and corresponding cDAI and tDAI are also not indicated. For example, when the PDCCH is either scheduling PDSCH for transmission to the NCR-MT and/or DL channel or signal to the NCR-Fwd for forwarding, it may not be necessary for the network to know whether the PDCCH is received or not (e.g., if HARQ-ACK feedback for the correspondingly scheduled channels is configured).

In certain embodiments, when the NCR is scheduled by the network to forward a DL channel or signal, and when only a single HARQ-ACK bit is configured to be reported by the NCR-MT for the duration for which the HARQ-ACK codebook is to be constructed, cDAI and tDAI are not configured and indicated via DCI to the NCR-MT corresponding to HARQ-ACK Group3. For example, based on one or more embodiments for HARQ-ACK Group3 discussed above, the NCR-MT may simply report ACK or NACK based on a total number of DL channels or signals that are expected to be scheduled. If a minimum required number of DL channels or signals are received above the configure threshold, then the NCR-MT can report back a single ACK. If, however, the minimum required number of DL channels or signals are not received above the configured threshold, then the NCR-MT can report back a single NACK.

In certain embodiments, the NCR is configured with two sets of HARQ-ACK groups. A first set of HARQ-ACK groups is associated with DL channels or signals that are scheduled and can be decoded at the NCR-MT such as PDCCH for transmitting side control information or PDSCH carrying side control information. A second set of HARQ-ACK groups is associated with measurement of the signal strength of all the DL channels or signals received by either the NCR-MT or the NCR-Fwd for either receiving and decoding or receiving and forwarding to UE(s). The NCR may, for example, measure the signal strength of PDCCH carrying side control information, the signal strength of PDSCH carrying side control information, and the signal strength of DL channels or signals to be forwarded to UE(s) by the NCR-Fwd.

In certain embodiments, another HARQ-ACK group (HARQ-ACK Group4) and corresponding cDAI and tDAI can be configured to the NCR that are associated with forwarding of UL channels or signals from UE(s) to the network. For example, when the NCR is configured to receive any UL channel or signal from same or different UEs, then the NCR can measure the signal strength on the configured receive (Rx) beams and apply similar methods as defined for HARQ-ACK Group3 to construct the sequence of HARQ-ACK bits for HARQ-ACK Group4 and concatenate to the combined HARQ-ACK codebook.

In certain embodiments, the scheduling of DL channels or signals for forwarding can be either explicitly scheduled or can be implied based on configuration of transmit beams (transmission configuration indication (TCI) and/or quasi co-location (QCL) assumption) at the NCR-Fwd for forwarding. From the network and NCR perspectives, for the generation of the HARQ-ACK codebook, one configured beam may correspond to one DL instance for which a corresponding measurement is performed. In one embodiment, the NCR may additionally be configured with a duration for measurement that corresponds to a single measurement instance. This may impact the number of HARQ-ACK bits corresponding to HARQ-ACK Group3.

In certain embodiments, different timings are configured to the NCR for HARQ-ACK processing. For example, a PDCCH-to-HARQ timing may be used to determine the minimum required duration for preparing the corresponding HARQ-ACK. A PDSCH-to-HARQ timing may be used to determine the minimum required duration for preparing the corresponding HARQ-ACK. A ChannelMeasurement-to-HARQ timing may be used to determine the minimum required duration for HARQ-ACK when the feedback corresponds radio link and/or beam quality rather than actual decoding of the channel or signal.

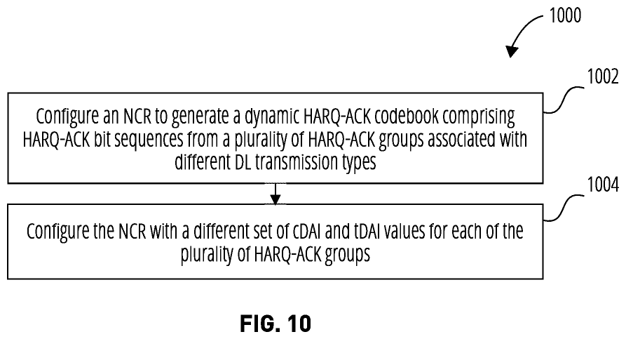

FIG. 10 is a method 1000 for wireless communication by a network device according to one embodiment. In block 1002, the method 1000 includes configuring a network-controlled repeater (NCR) to generate a dynamic hybrid automatic repeat request acknowledgement (HARQ-ACK) codebook comprising HARQ-ACK bit sequences from a plurality of HARQ-ACK groups associated with different downlink (DL) transmission types. In block 1004, the method 1000 includes configuring the NCR with a different set of counter downlink assignment index (cDAI) and total downlink assignment index (tDAI) values for each of the plurality of HARQ-ACK groups.

In certain embodiments of the method 1000, a first set of the cDAI and tDAI values is associated with a first HARQ-ACK group for physical downlink control channel (PDCCH) transmissions from a base station to a mobile termination of the NCR (NCR-MT). The PDCCH transmissions comprise at least one of first side control information, downlink (DL) scheduling information or a combination of the first side control information and the DL scheduling information.

In certain embodiments of the method 1000, a second set of the cDAI and tDAI values is associated with configuring a second HARQ-ACK group for scheduled physical downlink shared channel (PDSCH) transmissions from the base station to the NCR-MT. The scheduled PDSCH transmissions comprise second side control information.

In certain embodiments of the method 1000, a third set of the cDAI and tDAI values is associated with a third HARQ-ACK group for DL channels or signals from the base station for a forwarding entity of the NCR (NCR-Fwd) to forward to a user equipment (UE). In one embodiment, the DL channels or signals are explicitly scheduled by the base station for the NCR-Fwd to forward to the UE. In another embodiment, the DL channels or signals are implicitly scheduled for forwarding by association with configured or indicated beams that the NCR-Fwd is to forward to the UE. The dynamic HARQ-ACK codebook may comprise a combination of the first HARQ-ACK group generated based on the first set of the cDAI and tDAI values, the second HARQ-ACK group second set of the cDAI and tDAI values, and the third HARQ-ACK group third set of the cDAI and tDAI values.

In certain embodiments of the method 1000, when the NCR is scheduled to forward DL channels or signals from the base station to a user equipment (UE), and when only a signal HARQ-ACK bit is configured to be reported by the NCR in a duration for which the HARQ-ACK codebook is constructed, a third set of the cDAI and tDAI values is not associated with a third HARQ-ACK group for the DL channels or signals from the base station for the NCR to forward to the UE.

In certain embodiments of the method 1000, the different DL transmission types are configured on multiple component carriers, and the method 1000 further comprises incrementing each of the different sets of the cDAI and tDAI values based on corresponding configured DL transmissions in a first transmission time interval (TTI) across the multiple component carriers followed by a second TTI across the multiple component carriers. The first TTI may comprise a first slot and the second TTI may comprise a second slot.

In certain embodiments of the method 1000, the different DL transmission types are configured on multiple component carriers, and the method 1000 further comprises incrementing each of the different sets of the cDAI and tDAI values based on corresponding configured DL transmissions across all slots in a duration for HARQ-ACK feedback in a first component carrier of the multiple component carriers followed by all the slots in the duration in a second component carrier of the multiple component carriers.

In certain embodiments, the method 1000 further comprises configuring a control information format for indicating side control information to a mobile termination of the NCR (NCR-MT) to indicate one or more of the different sets of the cDAI and tDAI values, based on which of the different DL transmission types are configured by the control information format.

In certain embodiments, the method 1000 further comprises configuring the NCR with another set of cDAI and tDAI values associated with a HARQ-ACK group for forwarding uplink (UL) channels or signals from one or more user equipment (UE) to a base station.

In certain embodiments of the method 1000, the network device comprises one of a base station and the NCR.

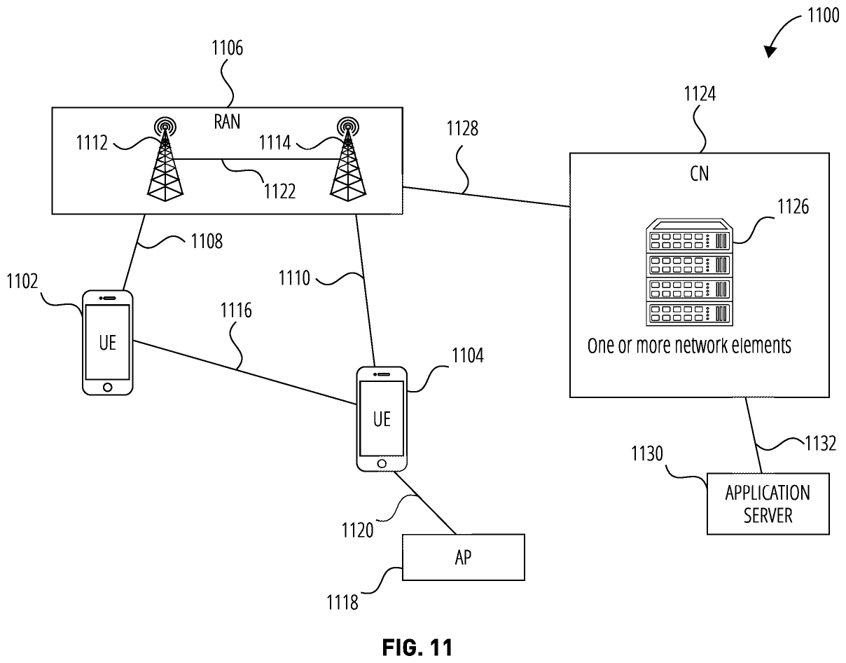

FIG. 11 illustrates an example architecture of a wireless communication system 1100, according to embodiments disclosed herein. The following description is provided for an example wireless communication system 1100 that operates in conjunction with the LTE system standards and/or 5G or NR system standards as provided by 3GPP technical specifications.

As shown by FIG. 11, the wireless communication system 1100 includes UE 1102 and UE 1104 (although any number of UEs may be used). In this example, the UE 1102 and the UE 1104 are illustrated as smartphones (e.g., handheld touchscreen mobile computing devices connectable to one or more cellular networks), but may also comprise any mobile or non-mobile computing device configured for wireless communication.

The UE 1102 and UE 1104 may be configured to communicatively couple with a RAN 1106. In embodiments, the RAN 1106 may be NG-RAN, E-UTRAN, etc. The UE 1102 and UE 1104 utilize connections (or channels) (shown as connection 1108 and connection 1110, respectively) with the RAN 1106, each of which comprises a physical communications interface. The RAN 1106 can include one or more base stations (such as base station 1112 and base station 1114) that enable the connection 1108 and connection 1110.

In this example, the connection 1108 and connection 1110 are air interfaces to enable such communicative coupling, and may be consistent with RAT(s) used by the RAN 1106, such as, for example, an LTE and/or NR.

In some embodiments, the UE 1102 and UE 1104 may also directly exchange communication data via a sidelink interface 1116. The UE 1104 is shown to be configured to access an access point (shown as AP 1118) via connection 1120. By way of example, the connection 1120 can comprise a local wireless connection, such as a connection consistent with any IEEE 802.11 protocol, wherein the AP 1118 may comprise a Wi-Fi® router. In this example, the AP 1118 may be connected to another network (for example, the Internet) without going through a CN 1124.

In embodiments, the UE 1102 and UE 1104 can be configured to communicate using orthogonal frequency division multiplexing (OFDM) communication signals with each other or with the base station 1112 and/or the base station 1114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1112 or base station 1114 may be implemented as one or more software entities running on server computers as part of a virtual network. In addition, or in other embodiments, the base station 1112 or base station 1114 may be configured to communicate with one another via interface 1122. In embodiments where the wireless communication system 1100 is an LTE system (e.g., when the CN 1124 is an EPC), the interface 1122 may be an X2 interface. The X2 interface may be defined between two or more base stations (e.g., two or more eNBs and the like) that connect to an EPC, and/or between two eNBs connecting to the EPC. In embodiments where the wireless communication system 1100 is an NR system (e.g., when CN 1124 is a 5GC), the interface 1122 may be an Xn interface. The Xn interface is defined between two or more base stations (e.g., two or more gNBs and the like) that connect to 5GC, between a base station 1112 (e.g., a gNB) connecting to 5GC and an eNB, and/or between two eNBs connecting to 5GC (e.g., CN 1124).

The RAN 1106 is shown to be communicatively coupled to the CN 1124. The CN 1124 may comprise one or more network elements 1126, which are configured to offer various data and telecommunications services to customers/subscribers (e.g., users of UE 1102 and UE 1104) who are connected to the CN 1124 via the RAN 1106. The components of the CN 1124 may be implemented in one physical device or separate physical devices including components to read and execute instructions from a machine-readable or computer-readable medium (e.g., a non-transitory machine-readable storage medium).

In embodiments, the CN 1124 may be an EPC, and the RAN 1106 may be connected with the CN 1124 via an S1 interface 1128. In embodiments, the S1 interface 1128 may be split into two parts, an S1 user plane (S1-U) interface, which carries traffic data between the base station 1112 or base station 1114 and a serving gateway (S-GW), and the S1-MME interface, which is a signaling interface between the base station 1112 or base station 1114 and mobility management entities (MMEs).

In embodiments, the CN 1124 may be a 5GC, and the RAN 1106 may be connected with the CN 1124 via an NG interface 1128. In embodiments, the NG interface 1128 may be split into two parts, an NG user plane (NG-U) interface, which carries traffic data between the base station 1112 or base station 1114 and a user plane function (UPF), and the S1 control plane (NG-C) interface, which is a signaling interface between the base station 1112 or base station 1114 and access and mobility management functions (AMFs).

Generally, an application server 1130 may be an element offering applications that use internet protocol (IP) bearer resources with the CN 1124 (e.g., packet switched data services). The application server 1130 can also be configured to support one or more communication services (e.g., VoIP sessions, group communication sessions, etc.) for the UE 1102 and UE 1104 via the CN 1124. The application server 1130 may communicate with the CN 1124 through an IP communications interface 1132.

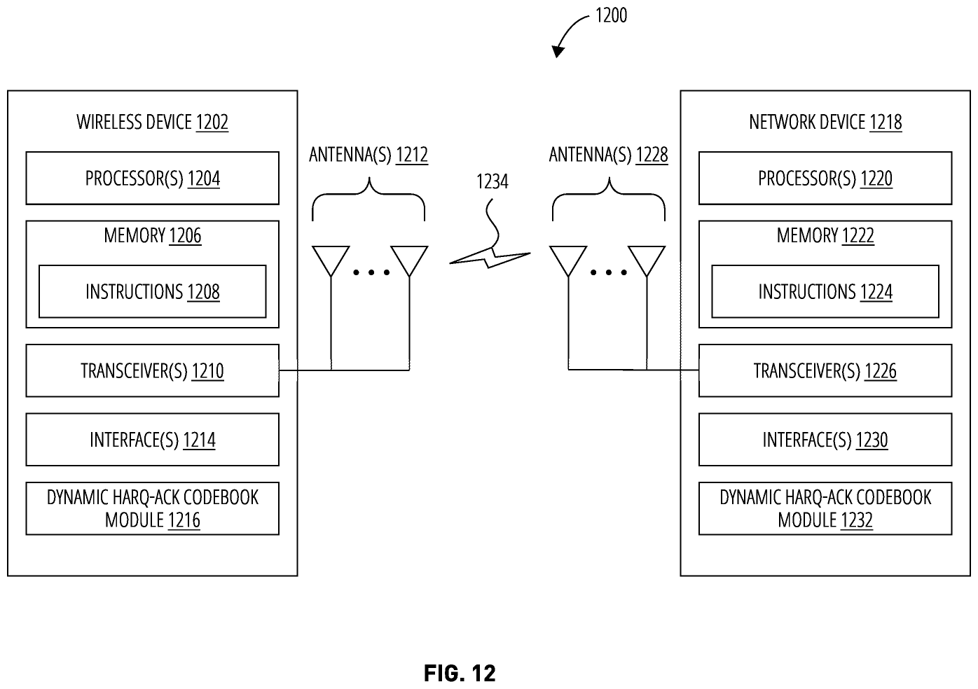

FIG. 12 illustrates a system 1200 for performing signaling 1234 between a wireless device 1202 and a network device 1218, according to embodiments disclosed herein. The system 1200 may be a portion of a wireless communications system as herein described. The wireless device 1202 may be, for example, a UE or an NCR of a wireless communication system. The network device 1218 may be, for example, a base station (e.g., an eNB or a gNB) of a wireless communication system.

The wireless device 1202 may include one or more processor(s) 1204. The processor(s) 1204 may execute instructions such that various operations of the wireless device 1202 are performed, as described herein. The processor(s) 1204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1202 may include a memory 1206. The memory 1206 may be a non-transitory computer-readable storage medium that stores instructions 1208 (which may include, for example, the instructions being executed by the processor(s) 1204). The instructions 1208 may also be referred to as program code or a computer program. The memory 1206 may also store data used by, and results computed by, the processor(s) 1204.

The wireless device 1202 may include one or more transceiver(s) 1210 that may include radio frequency (RF) transmitter and/or receiver circuitry that use the antenna(s) 1212 of the wireless device 1202 to facilitate signaling (e.g., the signaling 1234) to and/or from the wireless device 1202 with other devices (e.g., the network device 1218) according to corresponding RATs.

The wireless device 1202 may include one or more antenna(s) 1212 (e.g., one, two, four, or more). For embodiments with multiple antenna(s) 1212, the wireless device 1202 may leverage the spatial diversity of such multiple antenna(s) 1212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1202 may be accomplished according to precoding (or digital beamforming) that is applied at the wireless device 1202 that multiplexes the data streams across the antenna(s) 1212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1202 may implement analog beamforming techniques, whereby phases of the signals sent by the antenna(s) 1212 are relatively adjusted such that the (joint) transmission of the antenna(s) 1212 can be directed (this is sometimes referred to as beam steering).

The wireless device 1202 may include one or more interface(s) 1214. The interface(s) 1214 may be used to provide input to or output from the wireless device 1202. For example, a wireless device 1202 that is a UE may include interface(s) 1214 such as microphones, speakers, a touchscreen, buttons, and the like in order to allow for input and/or output to the UE by a user of the UE. Other interfaces of a UE or NCR may be made up of made up of transmitters, receivers, and other circuitry (e.g., other than the transceiver(s) 1210/antenna(s) 1212 already described) that allow for communication between the UE and other devices and may operate according to known protocols (e.g., Wi-Fi®, Bluetooth®, and the like). The interface(s) 1214 and/or the dynamic HARQ-ACK codebook module 1216 may include measurement circuitry for measuring channels or signals, as discussed herein.

The wireless device 1202 may include a dynamic HARQ-ACK codebook module 1216. The dynamic HARQ-ACK codebook module 1216 may be implemented via hardware, software, or combinations thereof. For example, the dynamic HARQ-ACK codebook module 1216 may be implemented as a processor, circuit, and/or instructions 1208 stored in the memory 1206 and executed by the processor(s) 1204. In some examples, the dynamic HARQ-ACK codebook module 1216 may be integrated within the processor(s) 1204 and/or the transceiver(s) 1210. For example, the dynamic HARQ-ACK codebook module 1216 may be implemented by a combination of software components (e.g., executed by a DSP or a general processor) and hardware components (e.g., logic gates and circuitry) within the processor(s) 1204 or the transceiver(s) 1210.

The dynamic HARQ-ACK codebook module 1216 may be used for various aspects of the present disclosure, for example, aspects of method 200, method 300, method 700, and/or method 1000.

The network device 1218 may include one or more processor(s) 1220. The processor(s) 1220 may execute instructions such that various operations of the network device 1218 are performed, as described herein. The processor(s) 1220 may include one or more baseband processors implemented using, for example, a CPU, a DSP, an ASIC, a controller, an FPGA device, another hardware device, a firmware device, or any combination thereof configured to perform the operations described herein.

The network device 1218 may include a memory 1222. The memory 1222 may be a non-transitory computer-readable storage medium that stores instructions 1224 (which may include, for example, the instructions being executed by the processor(s) 1220). The instructions 1224 may also be referred to as program code or a computer program. The memory 1222 may also store data used by, and results computed by, the processor(s) 1220.

The network device 1218 may include one or more transceiver(s) 1226 that may include RF transmitter and/or receiver circuitry that use the antenna(s) 1228 of the network device 1218 to facilitate signaling (e.g., the signaling 1234) to and/or from the network device 1218 with other devices (e.g., the wireless device 1202) according to corresponding RATs.

The network device 1218 may include one or more antenna(s) 1228 (e.g., one, two, four, or more). In embodiments having multiple antenna(s) 1228, the network device 1218 may perform MIMO, digital beamforming, analog beamforming, beam steering, etc., as has been described.

The network device 1218 may include one or more interface(s) 1230. The interface(s) 1230 may be used to provide input to or output from the network device 1218. For example, a network device 1218 that is a base station may include interface(s) 1230 made up of transmitters, receivers, and other circuitry (e.g., other than the transceiver(s) 1226/antenna(s) 1228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1218 may include a dynamic HARQ-ACK codebook module 1232. The dynamic HARQ-ACK codebook module 1232 may be implemented via hardware, software, or combinations thereof. For example, the dynamic HARQ-ACK codebook module 1232 may be implemented as a processor, circuit, and/or instructions 1224 stored in the memory 1222 and executed by the processor(s) 1220. In some examples, the dynamic HARQ-ACK codebook module 1232 may be integrated within the processor(s) 1220 and/or the transceiver(s) 1226. For example, the dynamic HARQ-ACK codebook module 1232 may be implemented by a combination of software components (e.g., executed by a DSP or a general processor) and hardware components (e.g., logic gates and circuitry) within the processor(s) 1220 or the transceiver(s) 1226.

The dynamic HARQ-ACK codebook module 1232 may be used for various aspects of the present disclosure, for example, aspects of method 400, method 800, and/or method 1000.

Embodiments contemplated herein include an apparatus comprising means to perform one or more elements of method 200, method 300, method 700, and/or method 1000. This apparatus may be, for example, an apparatus of an NCR or a UE (such as a wireless device 1202 that is an NCR or a UE, as described herein).

Embodiments contemplated herein include one or more non-transitory computer-readable media comprising instructions to cause an electronic device, upon execution of the instructions by one or more processors of the electronic device, to perform one or more elements of method 200, method 300, method 700, and/or method 1000. This non-transitory computer-readable media may be, for example, a memory of an NCR or a UE (such as a memory 1206 of a wireless device 1202 that is an NCR or a UE, as described herein).

Embodiments contemplated herein include an apparatus comprising logic, modules, or circuitry to perform one or more elements of method 200, method 300, method 700, and/or method 1000. This apparatus may be, for example, an apparatus of an NCR or a UE (such as a wireless device 1202 that is an NCR or a UE, as described herein).

Embodiments contemplated herein include an apparatus comprising: one or more processors and one or more computer-readable media comprising instructions that, when executed by the one or more processors, cause the one or more processors to perform one or more elements of method 200, method 300, method 700, and/or method 1000. This apparatus may be, for example, an apparatus of an NCR or a UE (such as a wireless device 1202 that is an NCR or a UE, as described herein).

Embodiments contemplated herein include a signal as described in or related to one or more elements of method 200, method 300, method 700, and/or method 1000.

Embodiments contemplated herein include a computer program or computer program product comprising instructions, wherein execution of the program by a processor is to cause the processor to carry out one or more elements of method 200, method 300, method 700, and/or method 1000. The processor may be a processor of an NCR or a UE (such as a processor(s) 1204 of a wireless device 1202 that is an NCR or a UE, as described herein). These instructions may be, for example, located in the processor and/or on a memory of the UE (such as a memory 1206 of a wireless device 1202 that is a UE, as described herein).

Embodiments contemplated herein include an apparatus comprising means to perform one or more elements of method 400, method 800, and/or method 1000. This apparatus may be, for example, an apparatus of a base station (such as a network device 1218 that is a base station, as described herein).

Embodiments contemplated herein include one or more non-transitory computer-readable media comprising instructions to cause an electronic device, upon execution of the instructions by one or more processors of the electronic device, to perform one or more elements of method 400, method 800, and/or method 1000. This non-transitory computer-readable media may be, for example, a memory of a base station (such as a memory 1222 of a network device 1218 that is a base station, as described herein).

Embodiments contemplated herein include an apparatus comprising logic, modules, or circuitry to perform one or more elements of method 400, method 800, and/or method 1000. This apparatus may be, for example, an apparatus of a base station (such as a network device 1218 that is a base station, as described herein).

Embodiments contemplated herein include an apparatus comprising: one or more processors and one or more computer-readable media comprising instructions that, when executed by the one or more processors, cause the one or more processors to perform one or more elements of method 400, method 800, and/or method 1000. This apparatus may be, for example, an apparatus of a base station (such as a network device 1218 that is a base station, as described herein).

Embodiments contemplated herein include a signal as described in or related to one or more elements of method 400, method 800, and/or method 1000.

Embodiments contemplated herein include a computer program or computer program product comprising instructions, wherein execution of the program by a processing element is to cause the processing element to carry out one or more elements of method 400, method 800, and/or method 1000. The processor may be a processor of a base station (such as a processor(s) 1220 of a network device 1218 that is a base station, as described herein). These instructions may be, for example, located in the processor and/or on a memory of the base station (such as a memory 1222 of a network device 1218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of wireless communication performed by a network-controlled repeater (NCR) configured to forward downlink (DL) channels or signals from a base station to a user equipment (UE), the method comprising:
determining a duration for which hybrid automatic repeat request acknowledgement (HARQ-ACK) feedback is configured;
determining a number of measurements of the DL channels or signals for which a single HARQ-ACK bit is reported;
determining, based on the number of measurements and a comparison with a success threshold for each of the measurements, an acknowledgement (ACK) or negative acknowledgement (NACK) for each configured HARQ-ACK bit in a first sequence of HARQ-ACK bits; and
constructing a dynamic HARQ-ACK codebook to send to the base station, the dynamic HARQ-ACK codebook comprising at least the first sequence of HARQ-ACK bits.

2. The method of claim 1, wherein determining the ACK or NACK comprises:
performing measurements of the DL channels or signals over the duration to produce measurement results indicating whether the DL channels or signals were successfully received or unsuccessfully received; and
comparing groups of the measurement results, according to the number of the measurements for which the single HARQ-ACK bit is reported, to the success threshold.

3. The method of claim 1, wherein determining the number of measurements for which the single HARQ-ACK bit is reported comprises processing an explicit indication of the number from the base station.

4. The method of claim 1, wherein determining the number of measurements for which the single HARQ-ACK bit is reported comprises processing an implicit indication of the number from the base station, the implicit indication corresponding to a number of slots or symbols.

5. The method of claim 1, wherein determining the number of measurements for which the single HARQ-ACK bit is reported corresponds to a total number of the DL channels or signals received over the duration.

6. The method of claim 1, wherein determining the number of the measurements for which the single HARQ-ACK bit is reported corresponds to a single one of the DL channels or signals.

7. The method of claim 1, further comprising receiving an indication of the success threshold from the base station, wherein the indication of the success threshold comprises a ratio or a percentage of successful receptions to overall transmissions of the DL channels or signals.

8. The method of claim 1, wherein the NCR is configured to forward the DL channels or signals on multiple component carriers, and wherein the method further comprises:
determining, per component carrier of the multiple component carriers, the number of measurements of the DL channels or signals for which the single HARQ-ACK bit is reported; and
determining, per component carrier of the multiple component carriers, the ACK or the NACK by measuring a signal strength of the DL channels or signals across a single component carrier,
wherein the dynamic HARQ-ACK codebook comprises a corresponding HARQ-ACK bit for each of the multiple component carriers.

9. The method of claim 1, wherein the NCR is configured to forward the DL channels or signals on multiple component carriers, and wherein the method further comprises:
determining, per transmission occasion across the multiple component carriers, the number of measurements of the DL channels or signals for which the single HARQ-ACK bit is reported; and
determining, per transmission occasion across the multiple component carriers, the ACK or the NACK by measuring a signal strength of the DL channels or signals of a single transmission occasion,
wherein the dynamic HARQ-ACK codebook comprises a corresponding HARQ-ACK bit for each transmission occasion.

10. The method of claim 1, wherein the NCR is configured to forward the DL channels or signals on multiple component carriers, and wherein the method further comprises reporting the single HARQ-ACK bit corresponding to all of the DL channels or signals across the multiple component carriers.

11. The method of claim 1, wherein constructing the dynamic HARQ-ACK codebook comprises concatenating the first sequence of HARQ-ACK bits with a second sequence of HARQ-ACK bits corresponding to scheduled physical downlink shared channel (PDSCH) transmissions from the base station to a mobile termination of the NCR.

12. The method of claim 11, wherein constructing the dynamic HARQ-ACK codebook comprises concatenating the first sequence of HARQ-ACK bits with a third sequence of HARQ-ACK bits corresponding to physical downlink control channel (PDCCH) transmissions from the base station to the mobile termination of the NCR.

13. A method of wireless communication performed by a base station, the method comprising:
configuring a network-controlled repeater (NCR) to forward downlink (DL) channels or signals from the base station to a user equipment (UE), by:
configuring the NCR with a duration for which hybrid automatic repeat request acknowledgement (HARQ-ACK) feedback is configured;
configuring the NCR with a number of measurements of the DL channels or signals for which a single HARQ-ACK bit is reported; and
configuring the NCR with a success threshold;
sending the DL channels or signals from the base station to the NCR to forward to the UE; and
in response to sending the DL channels or signals, receiving, at the base station from the NCR, a dynamic HARQ-ACK codebook comprising at least a first sequence of HARQ-ACK bits based on the number of measurements and the success threshold.

14. The method of claim 13, wherein the duration comprises a number of slots or symbols.

15. The method of claim 13, wherein configuring the NCR with a number of measurements comprises sending an explicit indication of the number from the base station to the NCR.

16. The method of claim 13, wherein configuring the NCR with the number of measurements comprises sending an implicit indication of the number from the base station, the implicit indication corresponding to a number of slots.

17. The method of claim 13, wherein configuring the NCR with the number of measurements comprises configuring the NCR to report the single HARQ-ACK bit for a total number of the DL channels or signals received over the duration.

18. The method of claim 13, wherein configuring the NCR with the number of measurements comprises configuring the NCR to report the single HARQ-ACK bit for a single one of the DL channels or signals.

19. The method of claim 13, wherein the success threshold comprises a ratio or a percentage of successful receptions to overall transmissions of the DL channels or signals.

20. The method of claim 13, wherein the DL channels or signals are communicated on multiple component carriers, and wherein the method further comprises configuring, per component carrier of the multiple component carriers, the NCR with the number of measurements of the DL channels or signals for which the single HARQ-ACK bit is reported, wherein the dynamic HARQ-ACK codebook comprises a corresponding HARQ-ACK bit for each of the multiple component carriers.

21-24. (canceled)
